(19) United States
(12) Patent Application Publication
(10) Pub. No.: US 2003/0070483 A1
(43) Pub. Date: Apr. 17, 2003

(54) Multiaxial inertial sensor system and method of producing same

(76) Inventor: Andre Mueller, Eisenach (DE)

Correspondence Address: KENYON & KENYON, ONE BROADWAY, NEW YORK, NY, 10004, US

(21) Appl. No.: 10/198,252

(22) Filed: Jul. 17, 2002

(30) Foreign Application Priority Data
Jul. 17, 2001 (DE) 101 34 620.4-33

(51) Int. Cl. G01P 1/02; G01P 15/18

(52) U.S. Cl. 73/493; 73/495; 73/866.5

(57) ABSTRACT

A multiaxial inertial sensor system, for example, a rotational rate and acceleration sensor system for driving dynamics regulation in motor vehicles, in which a plurality of sensor chips are assigned to respective sensor axes and are mounted on a plurality of rigid circuit substrates at a wafer level. The circuit substrates may be oriented according to a respective sensor axis and are electrically contacted to the substrate, and the circuit substrates are electrically and mechanically interconnected by flexible or rigid connecting structures.

### FIELD OF THE INVENTION

The present invention relates to inertial sensors and a multiaxial inertial sensor system for regulating the driving dynamics of motor vehicles, as well as a method of producing a multiaxial inertial sensor system.

### BACKGROUND INFORMATION

The combination of rigid circuit boards with flexible connectors (“flex-rigid printed circuit boards,” abbreviated to “FR-PCB”) is used in various ways by electronics companies and the electronics packaging industry.

Monoaxial inertial sensors (acceleration, rotational rate), such as those manufactured by Robert Bosch GmbH, may be used in motor vehicles, e.g., to detect rotational rate and acceleration.

Regulation of vehicle driving dynamics may require multiaxial sensor systems, for example, inertial sensor systems, which respond to rotational movements and acceleration of a vehicle in multiple directions in space. Such systems may be produced macroscopically, for example, by equipping circuit boards with respective sensor chips and then assembling the finished circuit boards to form a multiaxial inertial sensor system. It may be expensive to assemble such multiaxial structures, and assembly may include critical phases related to connecting the chips to contact structures on the circuit boards.

### SUMMARY OF THE INVENTION

An object of the present invention is to permit a micropacked multiaxial sensor system, so that manufacturing costs may be lowered and a noncritical connection of the sensor chips to the circuit boards may be guaranteed, or at least made more probable.

According to an exemplary embodiment of the present invention, this object is achieved by mounting a plurality of sensor chips assigned to the respective sensor axes on a plurality of rigid circuit substrates at a wafer level, the substrates may be oriented according to a respective sensor axis, the sensor chips are electrically contacted to the substrates, and flexible or rigid connecting structures electrically and mechanically interconnect the circuit substrates.

According to another exemplary embodiment according to the present invention, the rigid circuit substrates are printed circuit boards, which are electrically and mechanically interconnected by flexible connectors.

The circuit boards for two sensor axes may be constructed using a rigid circuit board part, a flexible connecting structure, and another rigid circuit board part. For three sensor axes, this structure may be supplemented by a second flexible connecting structure and a third rigid circuit board part rotated 90° relative to the original structure. The chips are mounted on the rigid circuit board parts of the FR-PCB circuit board, if they have not yet been placed upright, i.e., placed in their planar position, and they are contacted electrically. Due to the flexible mechanical and electrical connection of the FR-PCB circuit board, the structure may then be placed upright, to yield the desired shape of a multiaxial inertial sensor, and then secured in the multidimensional form by housing walls.

Sensor elements and analyzer circuit chips on a wafer level may be applied in any desired combination to the rigid circuit board parts of the FR-PCB structure, such as acceleration sensors and rotational rate sensors in three dimensions. Only one sensor, for example, may be applied in one direction, with two other sensors each applied in the other directions. One analyzer circuit chip, for example, may be applied for each individual sensor element chip or, alternatively, one common analyzer circuit may be applied for all the sensor chips. For connecting the sensor chips and the analyzer circuit chips, joining methods may be used, such as die-bond techniques, gluing, and/or soldering, for example, wire bonding or flip-chip assembly for electrically connecting the sensor and analyzer circuit chips.

The shape of the housing depends on the shape of the rigid circuit board parts, but may still be standardized. The material for the housing may be any substance that complies with the environmental safety requirements of the product, e.g., steel, ceramic and/or plastic. The housing may be equipped with stop marks for securing the rigid circuit board parts. For example, adhesive techniques, optionally in combination with mechanical clips, may be used to secure the rigid circuit board parts on the housing. The connection should not negatively effect the mode spectrum of the sensors. The housing may then be cast using casting compounds, such as epoxy resins, silicones or polyurethanes.

In another exemplary embodiment according to the present invention, a multiaxial inertial sensor system has an integrated rigid multidimensional 3D-MID circuit board structure as the rigid circuit board substrates and the connecting structures joining them. 3D-MID circuit board structures are three-dimensional “molded interconnect devices” that use thermoplastics and structured metal plating and allow the production of 3D injection-molded circuit element carriers. Such 3D-MID circuit board structures may be used as a substrate for securing and electrically connecting sensor element chips and analyzer circuit chips at the wafer level. For this purpose, the chips are mounted on the multidimensional 3D-MID circuit boards and contacted electrically, for example, by metal plating. The 3D-MID circuit board may be enclosed in a conventional housing. The chips, with or without the circuit board, may be sheathed in a sealing casting compound in the housing to protect them from ambient effects.

It is believed that advantages of an exemplary multiaxial inertial sensor system according to the present invention include the following:

Since the system is mounted as a block, the manufacturing cost of an exemplary multiaxial inertial sensor system according to the present invention may be lower compared with a design composed of microscopic components.

Since the electric connection of the rigid circuit board parts is established at the time of manufacture, the connections may be more reliable and the connection procedure may not be as critical, since the circuit board has not yet been fitted with the chips.

The chips may be mounted using conventional technologies, while the circuit boards are in a flat state.

Using a 3D-MID circuit board, multidimensionality may be provided.

If the 3D-MID circuit board is used, it may be identical to the housing.

The following description describes exemplary multiaxial inertial sensor systems according to the present invention, as well as exemplary manufacturing steps according to the present invention for manufacturing an inertial sensor system.

### BRIEF DESCRIPTION OF THE DRAWINGS

FIG. 1 is a top schematic view of a first exemplary multiaxial inertial sensor system according to the present invention for two dimensions in non-upright form.

FIG. 2 is a diagram of the exemplary multiaxial inertial sensor system of FIG. 1, secured by the housing walls in a three-dimensional upright form.

FIG. 3 is a perspective view of a second exemplary multiaxial inertial sensor system according to the present invention using a 3D-MID circuit board.

### DETAILED DESCRIPTION

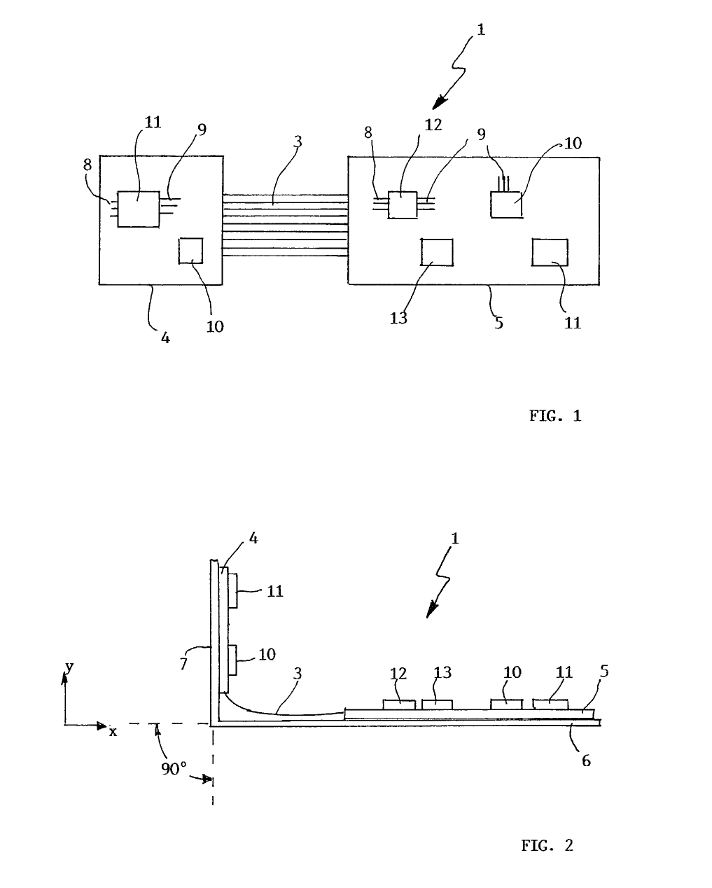

FIG. 1 shows a top planar view of a first exemplary biaxial inertial sensor system 1 for two sensor axes. FIG. 1 shows the biaxial inertial sensor system 1 in a position, in which it has not yet been placed upright. The biaxial inertial sensor system 1 includes sensor chips 10, 12 and analyzer circuit chips 11, 13, which are mounted on a first printed circuit board 4 and a second printed circuit board 5, and are electrically contacted to contact elements 8 and circuit board elements 9 of printed circuit boards 4 and 5.

As shown in FIG. 1, the two rigid printed circuit boards 4 and 5 are mechanically and electrically connected by a flexible connector 3, so that the two rigid printed circuit boards 4 and 5 may be positioned in a three-dimensional shape, so that sensor chips 10, 12 may each assume a position oriented with a respective sensor axis.

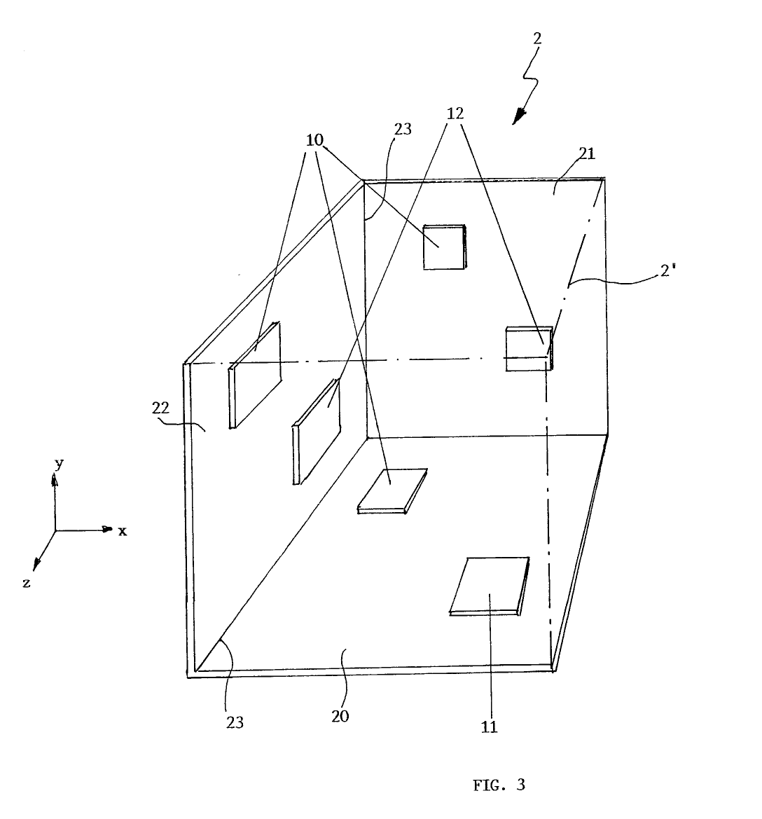

Such a position is illustrated in FIG. 2, in which the two rigid printed circuit boards 4, 5 are supported by housing walls 7, 6 perpendicular to one another, so that respective sensor chips 10, 12 are aligned in x and y directions on circuit boards 4 and 5.

In addition to sensor chips 10 and 12, the multiaxial inertial sensor system also includes analyzer circuit chips 11, 13. Sensor chips 10, 12 and analyzer circuit chips 11, 13 may be applied to the two printed circuit boards 4, 5 in any desired combination, e.g., as acceleration and rotational rate chips in all three dimensions; only one sensor in one direction, with two sensors each in the other directions; one common analyzer circuit chip for each individual sensor chip or one analyzer circuit chip for all the sensor chips. Die-bond techniques, e.g., gluing and soldering, may be used as the joining techniques for securing purposes and wire bonding or flip-chip methods may be used for the electric connection.

For three dimensions, the two-dimensional structure of FIGS. 1 to 2 may be supplemented by one flexible part and one rigid part rotated 90° relative to the two-dimensional structure of FIGS. 1 and 2.

The shape of the housing depends on the shape of the rigid circuit board parts, e.g., circuit boards 4 and 5 in FIGS. 1 and 2, but may be standardized. The material for the housing may include materials that comply with environmental safety requirements applicable to the product, e.g., steel, ceramic, plastic. The housing may be equipped with stop marks (not shown) for securing rigid circuit board parts 4, 5.

For example, adhesive techniques may be used for securing, alone or in combination with mechanical clips. The connection should not negatively effect the mode spectrum of the sensors.

Epoxy resins, silicones or polyurethanes, for example, may be used as casting compounds for casting the chips and/or the circuit boards in the housing to protect them from ambient influences.

FIG. 3 shows a second exemplary multiaxial inertial sensor system 2 according to the present invention, in which a 3D-MID circuit board, composed of parts 29, 21 and 22, is arranged in three mutually perpendicular directions x, y and z. This three-dimensional structure has an open cuboid shape with three mutually perpendicular planar parts interconnected electrically and mechanically by rigid connecting edges 23. Sensor elements 10, 12 and analyzer circuit chip 11 may be implemented in any desired combination, such as acceleration sensors and rotational rate sensors 10, 12 in three dimensions. Only one sensor chip, for example, may be applied in one direction, with two sensors chips 10, 12 each applied in the other directions. One analyzer chip 11, for example, may be applied for each individual sensor chip or, alternatively, one common analyzer circuit chip 11 may be applied for all the sensor chips. Joining techniques for securing may include die-bonding techniques, e.g., gluing or soldering, and wire bonding or flip-chip assembly may be used for the electrical connection.

If an outer housing is used, its shape will depend on the shape of the 3D-MID circuit board, although the housing may be standardized. Suitable materials for the housing include materials that comply with the environmental safety requirements of the product, e.g., steel, ceramic, plastic. The housing may be equipped with stop marks (not shown) to secure the 3D-MID circuit board. Adhesive techniques, optionally in combination with mechanical clips, may be used for securing. The connection should not negatively effect the mode spectrum of the sensors.

When no outer housing is used, the 3D-MID circuit board, which is composed of planar parts 20, 21 and 22, may be supplemented by an inverse part 2′ to form a closed cuboid shape, as shown in FIG. 3. Ultrasonic welding, for example, may be used for this purpose. The circuit board material should meet the increased demands of direct contact with the environment. HT thermoplastics, e.g., polyetherimide, have been investigated for use as exemplary 3D-MID circuit boards according to the present invention. The casting compounds may include epoxy resins, silicones or polyurethanes.

FIG. 3 shows a second exemplary multiaxial inertial sensor system 2 according to the present invention, in which a multidimensional 3D-MID circuit board structure is used as the substrate for wafer-level-packed sensor element 10, 11 and chips of analyzer circuit 11. Metal plating electrically contacts the circuit board. The 3D-MID circuit board may be repacked in a conventional housing. It is believed that this exemplary multiaxial inertial sensor system 2 according to the present invention offers the following advantages:

Since the system is mounted as a block, it may incur less manufacturing cost compared with a design of microscopic components.

Since electric connection of the rigid circuit board parts are produced at the time of manufacture, the connection may be more reliable and less critical, since the circuit board has not yet been fitted with the chips.

The system may already be multidimensional, due to the 3D-MID circuit board structure.

the 3D-MID circuit board may be identical to the housing.

What is claimed is:

1. A multiaxial inertial sensor system, comprising:
a plurality of rigid circuit substrates;
connecting structures including one of flexible and rigid structures electrically and mechanically interconnecting the plurality of rigid circuit substrates; and
a plurality of sensor chips mounted on the plurality of rigid circuit substrates at a wafer level, the plurality of sensor chips electrically contacting the plurality of rigid circuit substrates;
wherein each of the plurality of sensor chips is assigned to a respective sensor axis.

2. The sensor system of claim 1, wherein the multiaxial inertial sensor system includes a rotational rate and acceleration sensor system for driving dynamics regulation in a motor vehicle.

3. The sensor system of claim 1, wherein at least one of the plurality of sensor chips is oriented to the respective sensor axis.

4. The sensor system of claim 1, wherein the plurality of rigid circuit substrates include printed circuit boards, and the connecting structures include the flexible structures.

5. The sensor system of claim 4, further comprising:
multidimensional housing walls to secure the printed circuit boards in a desired oriented form.

6. The sensor system of claim 1, wherein the rigid circuit substrates and the connecting structures form a rigid multidimensional 3D-MID circuit board structure.

7. The sensor system of claim 6, further comprising:
a housing to enclose the 3D-MID circuit board structure.

8. The sensor system of claim 6, further comprising:
a corresponding inverse part connected to the 3D-MID circuit board structure to form a cuboid shape.

9. The sensor system of claim 1, wherein the plurality of rigid circuit substrates are aligned at an angle of approximately 90° relative to one another.

10. The sensor system of claim 1, wherein the plurality of sensor chips include at least one of rotational rate sensors and acceleration sensors.

11. The sensor system of claim 1, further comprising:
at least one analyzer circuit chip mounted on at least one of the plurality of rigid circuit substrates, and electrically connected to at least one of the plurality of sensor chips to analyze sensor signals.

12. A method of producing a multiaxial inertial sensor system, the method comprising:
producing a carrier and connection structure composed of a plurality of rigid circuit substrates, each of the plurality of rigid circuit substrates assigned to a respective sensor axis, the plurality of rigid circuit substrates including:
electric contact and printed conductor elements,
connecting structures including one of flexible and rigid connecting structures connecting the plurality of rigid circuit substrates to one another, and printed conductor elements;
providing sensor chips for a plurality of sensor axes at a wafer level; and
mechanically and electrically connecting the sensor chips to the electric contact elements of the plurality of rigid circuit substrates.

13. The method of claim 12, wherein the multiaxial inertial sensor system includes a rotational rate and acceleration sensor system.

14. The method of claim 12, wherein each of the plurality of rigid circuit substrates is aligned to the respective sensor axis.

15. The method of claim 14, wherein the plurality of rigid circuit substrates includes a plurality of printed circuit boards, and the connecting structures include flexible connectors in combination with the plurality of rigid circuit substrates, the method further comprising:
aligning each of the plurality of printed circuit boards to the respective sensor axis; and
fixing the printed circuit boards on suitably shaped multidimensional housing walls.

16. The method of claim 12, wherein the plurality of rigid circuit substrates and the connecting structures form an integral rigid multidimensional 3D-MID circuit board.

17. The method of claim 16, further comprising:
enclosing the 3D-MID circuit board by a housing.

18. The method of claim 16, further comprising:
connecting the 3D-MID circuit board to a corresponding inverse part, wherein the 3D-MID circuit board and the corresponding inverse part form a cuboid shape.

19. The method of claim 12, wherein the plurality of rigid circuit substrates are one of aligned and provided relative to one another at an angle of 90°.

20. The method of claim 12, further comprising:
mounting at least one analyzer circuit chip on at least one of the plurality of rigid circuit substrates at the wafer level; and
electrically connecting each of the at least one analyzer circuit chip to a corresponding one of the sensor chips to analyze sensor signals.
